(19) United States
(12) Patent Application Publication
(10) Pub. No.: US 2020/0134935 A1
(43) Pub. Date: Apr. 30, 2020

(54) METHOD FOR CAPTURING A STATE OF A PRODUCT AND METHOD FOR CONFIGURING THE PRODUCT AND A DATA NETWORK THEREFOR

(71) Applicant: Robert Bosch GmbH, Stuttgart (DE)

(72) Inventors: Sebastian Vornwald, Wuerzburg (DE); Adrien Mouaffo Tiadjio, New-Ulm (DE); Christoph Maier, Kleinostheim (DE); Jochen Mueller, Backnang (DE); Patric Brand, Sennfeld (DE); Peter Rehbein, Erlabrunn (DE); Roman Ritter, Stuttgart (DE); Thomas Inderwies, Frammersbach (DE); Wolfgang Rueppel, Frammersbach (DE)

(21) Appl. No.: 16/169,660

(22) Filed: Oct. 24, 2018

(51) Int. Cl. G07C 5/00; E02F 9/26; H04W 4/44; H04W 4/80

(52) U.S. Cl. CPC G07C 5/008; H04W 4/80; H04W 4/44; E02F 9/264

(57) ABSTRACT

A method, for capturing a state of a product using a capture unit associated with the product, includes receiving with the capture unit at least one of an identification of the product and an identification of the capture unit. The identification is stored in a memory of the capture unit. At least one measured value is recorded using at least one sensor of the capture unit, and stored in the memory of the capture unit. An output signal including at least the identification and the at least one measured value is outputted to a reading unit using the capture unit.

This application claims priority under 35 U.S.C. § 119 to patent application no. DE 10 2017 219 383.2, filed on Oct. 27, 2017 in Germany, the disclosure of which is incorporated herein by reference in its entirety.

The disclosure relates to a method for capturing a state of a product. Moreover, the disclosure relates to a method for configuring a product and a data network for this method.

### BACKGROUND

It is known practice to equip products with electronic subassemblies such as, for example, what are known as beacons that can be used to capture information about the product electronically. As such, by way of example, known beacons use BLE (Bluetooth®) to beam product-related data to a mobile phone, to a computer or to a gateway. These data can then be displayed on a mobile phone screen, for example. Capturing information about a product in this manner is unsatisfactory for many applications, however.

### SUMMARY

Against this background, it is an object of the disclosure presented here to solve or at least reduce the technical problems outlined in connection with the prior art. The aim in particular is to present a method for capturing a state of a product and methods for configuring a product therefor that can be used to capture the state of a product particularly comprehensively.

This object is achieved by means of a method for capturing a state of a product and by means of a method for configuring the product and a data network therefor according to the features of the description, claims, and drawings. The features individually listed in the disclosure are combinable with one another in any manner that makes technological sense, and can be complemented by explanatory substantive matter from the description, with further variant embodiments of the disclosure being demonstrated.

A method for capturing a state of a product using a capture unit associated with the product is presented. The method comprises at least the following steps:

a) receiving an identification of the product and/or an identification of the capture unit using the capture unit,
b) storing the identification of the product and/or the identification of the capture unit in a memory of the capture unit,
c) recording at least one measured value using at least one sensor of the capture unit,
d) storing the at least one measured value recorded in step c) in the memory of the capture unit,
e) outputting an output signal using the capture unit to a reading unit, wherein the output signal comprises at least the identification of the product and/or the identification of the capture unit and also at least the at least one measured value recorded in step c).

The product may in particular be a component of a machine tool, of a production machine, of a vehicle or of an industrial installation, for example. In particular, the product may be a valve, an actuator, a motor or a passive structure, such as, for example, a supporting structure. The method described is not restricted to the cited products, however.

The method described can be used to capture the state of the product. The state of the product can in particular comprise whether the product is damaged and/or whether the product is operating correctly. Wear phenomena can also be captured from the state of the product. As such, it is possible to detect from the state of the product whether and when the product needs to be serviced, replaced or repaired, for example. The method described can be used by a user, by reading the capture unit associated with the product, to tell in particular what product is involved and what history the product has. The history of the product is intended to be understood to mean in particular details about operation of the product. As such, for example, the history can include how long a product was in operation. In the case of a valve as the product, the history can include when and/or how often the valve was switched, for example.

The method described provides a user with the advantage in particular that the user can identify the product, for example by means of a product number. At the same time, the user can gain knowledge of the history of the product. On the basis of the product number (and knowledge arising therefrom, for example concerning a particular configuration of the product) and the history of the product, the user can decide whether the product needs to be replaced, for example.

The method described is performed using the capture unit. The capture unit may in particular be an embedded system. This means in particular that the capture unit is intended and configured to record one or more measured variables. The capture unit can be referred to as a sensor subassembly. Preferably, the capture unit is of autarkic design, that is to say can be operated without a cable connection. To this end, the capture unit preferably has at least one battery. The capture unit additionally preferably has at least one sensor, a microprocessor and a communication module. The communication module can be used by the reading unit to communicate with external devices, in particular with the reading unit. The microprocessor of the capture unit is preferably linked to a memory of the capture unit.

The fact that the capture unit is associated with the product means in particular that the capture unit can be used to record measured values suitable for describing the state of the product. These may in particular be measured values recorded directly in the region of the product. As such, it is preferred for the capture unit to be fitted to the product. By way of example, the capture unit may be adhesively bonded to a packaging or to a surface of the product. Additionally, the capture unit has the memory, which can be used to store data.

In particular in order to be able to detect what product is involved when reading the capture unit, steps a) and b) of the method described are performed. Steps a) and b) are preferably performed directly after manufacture of the product, that is to say at the beginning of the product life. Step a) involves an identification of the product and/or an identification of the capture unit being transmitted to the capture unit and received thereby. Preferably, both the identification of the product and the identification of the capture unit are received.

The identification of the product and the identification of the capture unit may in particular be a serial number that is allocated once for the product or for the capture unit. Therefore, the serial number allows explicit identification of the product or of the capture unit. The identification may also be a type number that is allocated once for a group of products or capture units. Therefore, the type number allows identification of the product or of the capture unit insofar as a model and/or a type of the product or of the capture unit can be identified, for example. Preferably, all products and all capture units having the same type number are of the same physical design. Therefore, the type number can explicitly provide information about how the product or the capture unit is configured.

If only the identification of the capture unit is used, it can be considered to be an identification of the combination of capture unit and product. In this respect, the product can be identified by the identification of the capture unit. This is the case in particular when the capture unit is connected to the product, for example as a result of the capture unit being adhesively bonded to the product.

The identifications are preferably transmitted from a computer system to the capture unit. The identifications can in this case be stored in the computer system and transmitted to the capture unit. It is also possible for the identifications to be produced using the computer system in step a) and to be directly transmitted to the capture unit and stored in the computer system. The transmission to the capture unit can be effected by means of a wireless connection, in particular by radio, Bluetooth®, WLAN, infrared, mobile radio and/or near field communication. It is also possible for the transmission to be effected by means of a cable connection.

After the identifications have been received by the capture unit, they are stored in the memory of the capture unit according to step b).

It is also possible for the identification of the capture unit to be saved in the memory of the capture unit during the actual manufacture of the capture unit. In this case too, the identification of the capture unit has first of all been received using the capture unit and saved in the memory of the capture unit. In this respect, steps a) and b) have also been performed for the identification of the capture unit. It is in particular possible for steps a) and b) to be performed for the identification of the capture unit and for the identification of the product independently of one another. As such, the identification of the capture unit can be received and stored first and then the identification of the product can be received and stored.

Additionally, the method described can be used to capture the history of the product. In particular in this regard, steps c) and d) of the method described are performed. Step c) is preferably performed during operation or use of the product as intended. Step c) involves at least one sensor of the capture unit being used to record at least one measured value. As a result, it is possible to capture what conditions the product has been exposed to since its manufacture, to what extent it was in operation or has been used and/or whether particular events such as damage events, for example, have occurred since manufacture, for example.

During operation of the product, step c) can result in data being collected and being stored according to step d). These may in particular be data concerning a transport, a startup and/or a use of the product. This can achieve the effect that times of use and/or sensor events can be taken into consideration for the decision about replacement of the product. By way of example, step c) can involve capturing how often shocks (for example as a result of impacts) have occurred during operation of the product and/or how many hours the product was in operation.

The at least one measured value recorded in step c) is stored in the memory of the capture unit in step d). This can be effected in particular directly after the applicable measured value is recorded.

It is preferred for only such measured values as are of particular importance to be stored according to step d). As such, by way of example, step c) can involve monitoring whether a measured variable exceeds prescribable limit values. In this case, the measured value can then be stored only if the measured value has exceeded a limit value. It is thus possible, by way of example, for storage to take place only when an impact having a minimum strength has occurred.

The insights about the product that are captured according to steps a) and c) can be read according to step e). Step e) involves an output signal being output to the reading unit using the capture unit. This can be effected in particular by means of a wireless connection, in particular by radio, Bluetooth®, WLAN, infrared, mobile radio and/or near field communication.

The output signal comprises at least the identification of the product and/or the identification of the capture unit. Moreover, the output signal comprises at least the at least one measured value recorded in step c). The output signal is received by the reading unit. The reading unit is preferably a smartphone or a tablet. After the output signal has been received using the reader, the output signal is preferably visualized using a screen of the reading unit. As such, a user can gain knowledge of the details saved in the memory of the capture unit according to steps b) and d).

In particular, the user can use the method described to gain knowledge of what product is involved and whether replacement of this product is necessary. It is therefore possible to facilitate identifying a product such as, by way of example, a valve, a pump or a controller even during operation (“in the field” or in a “brown-field” situation) and taking the history thereof into consideration for the decision concerning replacement of the product.

In a preferred embodiment of the method, step a) additionally involves at least one property of the product being received, wherein step b) additionally involves the at least one property being stored in the memory of the capture unit, and wherein the output signal that is output according to step e) additionally comprises the at least one property.

In addition to the at least one measured value recorded according to step c), the state of the product can also be characterized by means of the at least one property. As such, the at least one property is preferably at least one of the following properties:
a time of production of the product,
a time of first startup of the product,
a period of operation of the product to date.

The knowledge of such properties can in particular be taken into consideration for the decision regarding whether the product needs to be replaced. As such, by way of example, replacement of the product can be performed after a prescribable time has elapsed and/or after use to a prescribable extent (for example characterized by how frequently a valve has been switched).

In a further preferred embodiment of the method, the at least one measured value is recorded in step c) at least for one of the following variables:
an acceleration,
a temperature,
a light intensity,
a magnetic flux density.

The product can in particular perform an activity itself during operation. As such, the operation of the product can in particular comprise moving components of the product being moved. This can be effected by a drive provided outside the product or by a drive of the product. By way of example, a valve as the product can be opened and closed. It is also possible for the product to be moved during operation of an installation in which it is installed. Such movement of moving components of the product and/or of the product as a whole can in particular be captured using an acceleration sensor. By measuring the acceleration, it is possible to ascertain at what time a valve has been operated, for example. Further, the product may be exposed to vibrations during operation. These can come from the product itself or can be transmitted to the product from an external source. Measurement of vibrations using an acceleration sensor allows in particular knowledge about wear and/or damage to the product to be gained.

It is also possible for a light intensity to change during operation of the product. Measurement of the light intensity makes it possible to ascertain, in particular for a light-sensitive product, whether said product is damaged during operation or whether there is the threat of damage. It is also possible for light to be emitted by the product during operation thereof. By way of example, the capture unit can thus be used to capture whether, when and at what intensity a light source of the product emits light.

From a temperature to which the product is exposed during operation, it is possible to infer a manner of operation of the product. If the product is a motor, for example, a high measured temperature can indicate that the motor is switched on. An excessive temperature can indicate the presence of a fault in the product and/or in the surroundings thereof.

The magnetic flux density can be used to detect an electromagnetic impulse, for example. Such an impulse can be emitted by the product and/or received thereby during operation, for example. An electromagnetic impulse from an external source can also lead to damage of the product.

In a further preferred embodiment, the method additionally comprises the following method step: f) accessing a data network using the reading unit and checking whether the identification of the product that is output by the capture unit according to step e) and/or the identification of the capture unit that is output by the capture unit according to step e) are saved in the data network.

In the present embodiment, it is in particular possible to establish whether the product is an original part or a counterfeit. As such, every original part is preferably saved by registration in a database of the data network. To this end, the identification of the product and/or the identification of the capture unit associated with the product may be saved in the data network. Preferably, both the identification of the product and the identification of the capture unit associated with the product are saved in the data network. If the capture unit is now read using the reader, the reader can be used, by accessing the data network, to establish whether the identification of the product and/or the identification of the capture unit are saved in the data network. If this is not the case, this may in particular be an indication that the product is a fake.

The method described can thus be used to achieve counterfeit protection by using explicit identifications (such as, for example, material numbers) in particular also in conjunction with the history of the product. The explicit identification of the product and of the capture unit and the history of the product can be used to provide counterfeit protection, because only the identification of the product in conjunction with the identification of the capture unit is saved in the data network (for example with a unique MAC address according to what is known as the LIPID approach). If the history of the product is retrieved (by reading using the reader) for servicing purposes, a check on the authenticity of the product can be performed at the same time.

The data network is preferably a (data) cloud. It may also be a computer network. The data network can be accessed using the reading unit in particular by means of a wireless connection such as a WLAN or mobile radio connection. The data network preferably comprises a database in which the identification of the product and/or the identification of the capture unit is saved.

In a further preferred embodiment of the method, the output signal that is output in step e) comprises the identification of the product and the identification of the capture unit. Step f) additionally involves checking whether the identification of the product that is output according to step e) is saved in the data network as being associated with the identification of the capture unit that is ascertained according to step e).

The fact that the output signal comprises both the identification of the product and the identification of the capture unit can be made possible in particular by virtue of step a) involving the identification of the product and the identification of the capture unit being received and step b) involving the identification of the product and the identification of the capture unit being stored in the memory of the capture unit.

This embodiment does not just involve verifying whether the identification of the product and the identification of the capture unit are saved as such in the data network. Additionally, it is also verified whether the combination of capture unit and product is saved in the data network. This allows particularly safe counterfeit protection to be achieved.

In a further preferred embodiment of the method, a position of the reading unit is ascertained when receiving the output signal using the reading unit and is stored in the reading unit and/or transmitted to a data network.

If it is detected that the product is a fake, the knowledge of the position of the fake product may be of advantage. As such, by way of example, it is possible to ascertain where (that is to say, by way of example, in which country, in which city, in which company) a fake product has been detected as such. Knowledge of this kind can help to ascertain the origin of the fake product.

The position of the reading unit can in particular be ascertained by means of satellite navigation, in particular by means of GPS (Global Positioning System). Assuming that the reading unit is close to the capture unit or the product during reading (which is preferred), the position of the reading unit can be equated with the position of the product.

In a further preferred embodiment of the method, step e) is carried out after a request signal has been received using the capture unit.

Step e) can be performed in particular at the request of a user in this embodiment. As such, the user can in particular bring the reader close to the capture unit and read the capture unit using the reading unit. To this end, the user can prompt the reading unit to output the request signal to the capture unit. The request signal can be provided by radio, Bluetooth®, WLAN, infrared, mobile radio and/or near field communication, for example.

It is (if applicable alternatively) possible for the output signal to be output automatically by the capture unit in step e). This can be triggered by time elapsing (and hence in particular at prescribed times) and/or by events (such as the exceedance of a limit value), for example. In that case, it is preferred for the capture unit and the trigger unit to communicate via a connection, which allows communication over a longer range too. Possibilities in this regard are in particular radio, Bluetooth®, WLAN, infrared and/or mobile radio.

In a further preferred embodiment of the method, the output signal is output in step e) by means of near field communication.

In this embodiment, the output signal can be transmitted to the trigger unit when the reading unit is close to the capture unit. Thus, in this embodiment, it is preferred for the output signal to be output after the capture unit has received a request signal from the reading unit.

In a further preferred embodiment of the method, the product is an operating component of a work machine.

The method described is in particular intended and configured for monitoring industrial production installations. The installation may in particular be a machine used to manufacture products in partially or fully automated fashion. The installation may also be a work machine such as an excavator or a crane.

As a further aspect, a method for configuring a product and a data network for capture of a state of the product using the method described is presented, comprising at least the following method steps:

A) fitting the capture unit to the product,
B) ascertaining the identification of the product and the identification of the capture unit, and
C) saving the identification ascertained according to step B) in the data network in a mutually associated manner.

The particular advantages and configuration features described for the method for capturing a state of a product are applicable and transferable to the described method for configuring the product, and vice versa.

The described method for configuring the product and the data network is in particular intended and configured for such embodiments of the method for capturing the state of the product as involve the output signal that is output in step e) comprising the identification of the product and the identification of the capture unit. This can be made possible by virtue of step a) involving the identification of the product and the identification of the capture unit being received and step b) involving the identification of the product and the identification of the capture unit being stored in the memory of the capture unit.

The method for configuring the product and the data network is preferably performed directly after manufacture of the product, that is to say at the beginning of the product life. This is effected preferably after steps a) and b) and before step c) of the described method for capturing the state of the product. According to step A), the capture unit is fitted to the product. This can be accomplished by adhesively bonding the capture unit to the product or a packaging of the product, for example. Step B) involves the identifications of the product and the capture unit being ascertained. To this end, the identifications are preferably read from the capture unit. This can be accomplished using a configurer, for example. The configurer may be different from the reading unit used in step e) or may be of the same physical design as it. It is also possible for a device to be used both as configurer in step B) and as reading unit in step e). The identifications are saved in the data network in a mutually associated manner in step C). This is in particular advantageous for performing the described method for capturing the state of the product, in which counterfeit protection is achieved by verifying whether the identifications that are output according to step e) are saved in association with one another in the data network.

By way of example, after the capture unit is fitted to the product in step A), the type of the component can be identified according to step B) at the beginning of the startup of a product by using a network-compatible terminal, e.g. by inputting the type part number and/or by photographing the products or an identification plate of the product. Moreover, the capture unit is identified, for example by means of wireless technology (NFC). Step C) can then involve a connection being set up to a “cloud backend” as the data network and the data collected according to step B) being transmitted.

As a further aspect, a capture unit is presented that is intended and configured for use in one of the methods described.

The particular advantages and configuration features described for the method for capturing a state of a product and for the method for configuring the product and the data network for this method are applicable and transferable to the capture unit described.

As a further aspect, a reading unit is presented that is intended and configured for use in the described method for capturing a state of a product.

The particular advantages and configuration features described for the method for capturing a state of a product and for the method for configuring the product and the data network for this method are applicable and transferable to the reading unit described.

As a further aspect, a data network is presented that is intended and configured for use in the described method for capturing a state of a product.

The particular advantages and configuration features described for the method for capturing a state of a product and for the method for configuring the product and the data network for this method are applicable and transferable to the data network described.

### BRIEF DESCRIPTION OF THE DRAWINGS

The disclosure and the technical setting are explained in more detail below on the basis of the figures. The figures show an exemplary embodiment, to which the disclosure is not restricted, however. By way of clarification, it should be pointed out that the technical features illustrated in the figures can also be combined with features of other figures and/or the description without requiring other technical features of a figure to be adopted. Insofar as there is a technical need to combine forms of one technical feature with those of another, this is explicitly referenced or mentioned, which means that otherwise these features are freely combinable.

In the drawings:

FIG. 1: shows a depiction of a product having a capture unit associated with the product and also a reading unit and a data network,

FIG. 2: shows a depiction of a method for capturing a state of the product from FIG. 1 using the capture unit associated with the product,

FIG. 3: shows a depiction of a method for configuring the product and the data network for the method from FIG. 1,

FIG. 4: shows a depiction of a work machine having a plurality of products according to the embodiment from FIG. 1.

### DETAILED DESCRIPTION

FIG. 1 shows a product 2 having a capture unit 1 associated therewith. The capture unit 1 has a sensor 3, a battery 4, a microprocessor 5 and a communication module 6. The microprocessor 5 of the capture unit 1 is linked to a memory 13. The communication module 6 can be used by the capture unit 1 to communicate with a reading unit 7. The reading unit 7 can communicate with a data network 8.

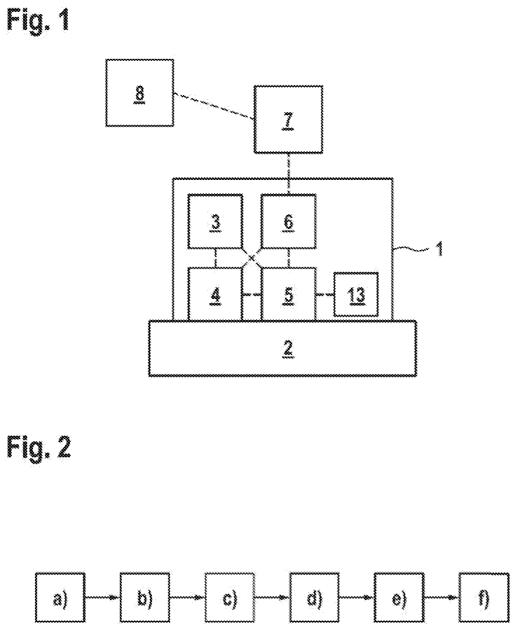

FIG. 2 shows a depiction of a method for capturing a state of the product 2 from FIG. 1 using the capture unit 1 associated with the product 2. The method comprises the following steps:

a) receiving an identification of the product 2 and an identification of the capture unit 1 and also at least one property of the product 2 using the capture unit 1,
b) storing the identification of the product 2 and the identification of the capture unit 1 and also the at least one property of the product 2 in the memory 13 of the capture unit 1,
c) recording at least one measured value using the sensor 3 of the capture unit 1,
d) storing the at least one measured value recorded in step c) in the memory 13 of the capture unit 1,
e) outputting an output signal using the capture unit 1 by means of near field communication to the reading unit 7 after a request signal has been received using the capture unit 1, wherein the output signal comprises at least the identification of the product 2 and/or the identification of the capture unit 1 and also at least the at least one measured value recorded in step c) and the at least one property of the product 2,
f) using the reading unit 7 to access the data network 8 and checking whether the identification of the product 2 that is output by the capture unit 1 according to step e) and the identification of the capture unit 1 that is output by the capture unit 1 according to step e) are saved in the data network 8. In this case, it is additionally verified whether the identification of the product 2 that is output according to step e) is saved in the data network 8 as being associated with the identification of the capture unit 1 that is ascertained according to step e).

The at least one measured value is recorded in step c) at least for an acceleration, a temperature, a light intensity and/or a magnetic flux density.

The output signal is received using the reading unit 7. In this case, a position of the reading unit 7 is ascertained and is stored in the reading unit 7 and/or transmitted to the data network 8.

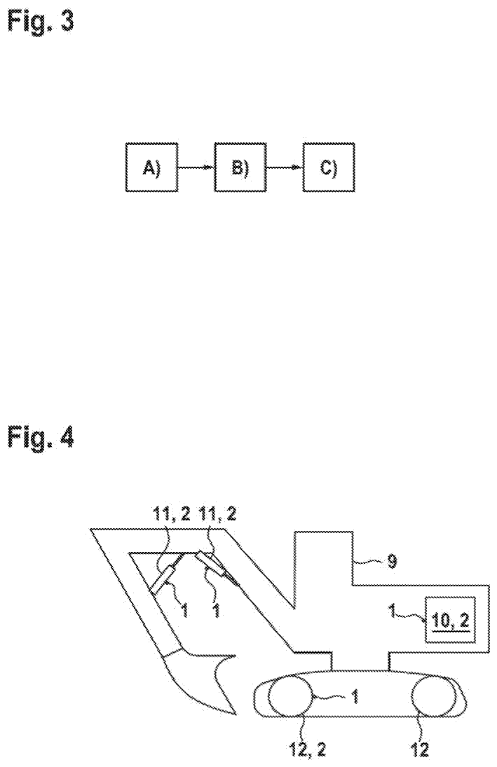

FIG. 3 shows a depiction of a method for configuring the product 2 and the data network 8 for the method from FIG. 2. The method comprises the following method steps:

A) fitting the capture unit 1 to the product 2,
B) ascertaining the identification of the product 2 and the identification of the capture unit 1, and
C) saving the identification ascertained according to step B) in the data network 8 in a mutually associated manner.

FIG. 4 shows a work machine 9. A respective capture unit 1 according to the embodiment from FIG. 1 is provided on a motor 10, on two hydraulic units 11 and on a chain drive 12. The motor 10, the two hydraulic units 11 and the chain drive 12 are products 2 within the context of the embodiment from FIG. 1. Capture units 1 can be used to capture the state of the products according to the method shown in FIG. 2. The method shown in FIG. 3 can be used to configure the products 2 and the data network 8 (not shown here) for that purpose.

### LIST OF REFERENCE SIGNS

1 Capture unit
2 Product
3 Sensor
4 Battery
5 Microprocessor
6 Communication module
7 Reading unit
8 Data network
9 Work machine
10 Motor
11 Hydraulic unit
12 Chain drive
13 Memory

What is claimed is:

1. A method for capturing a state of a product using a capture unit associated with the product, the method comprising:
receiving, using the capture unit, an identification of at least one of the product and the capture unit;
storing the identification in a memory of the capture unit;
recording, using at least one sensor of the capture unit, at least one measured value;
storing the at least one measured value in the memory of the capture unit; and
outputting, using the capture unit, an output signal to a reading unit, the output signal including at least the identification and the at least one measured value.

2. The method of claim 1, wherein:
receiving the identification includes receiving at least one property of the product;
storing the identification in the memory includes storing the at least one property in the memory; and
the output signal further includes the at least one property.

3. The method of claim 1, wherein the at least one measured value includes a value of at least one of an acceleration, a temperature, a light intensity, and a magnetic flux density.

4. The method of claim 1, further comprising:
accessing a data network using the reading unit, and determining whether the identification is saved in the data network.

5. The method of claim 4, wherein:
the received identification includes the identification of the product and the identification of the capture unit;
the output signal includes the identification of the product and the identification of the capture unit; and
accessing the data network includes determining whether the identification of the product is saved in the data network as associated with the identification of the capture unit.

6. The method of claim 1, further comprising:
in response to the reading unit receiving the output signal, ascertaining a position of the reading unit; and
at least one of:
storing the position of the reading unit in the reading unit; and
transmitting the position of the reading unit to a data network.

7. The method of claim 1, wherein the outputting of the output signal is performed in response to receiving a request signal using the capture unit.

8. The method of claim 1, wherein the outputting of the output signal is performed via near field communication.

9. The method of claim 1, wherein the product is an operating component of a work machine.

10. A method for configuring a product and a data network to enable capture of a state of the product with a capture unit, the method comprising:
fitting the capture unit to the product;
ascertaining an identification of the product and an identification of the capture unit; and
saving the identification of the product and the identification of the capture unit in the data network so as to be mutually associated.

11. A system for capturing a state of a product, comprising:
a capture unit associated with the product, the capture unit including:
a memory; and
at least one sensor;
wherein the capture unit is configured to:
receive an identification of at least one of the product and the capture unit;
store the identification in the memory;
record, with the at least one sensor, at least one measured value;
store the at least one measured value in the memory; and
output an output signal that includes at least the identification and the at least one measured value.

12. The system of claim 11, further comprising:
a reader unit, wherein the capture unit is configured to output the output signal to the reader unit.

13. The system of claim 12, further comprising:
a data network, the reading unit configured to access the data network and determine whether the identification is saved in the data network.

14. The system of claim 13, wherein the data network is configured to save an identification of the product and an identification of the capture unit so as to be mutually associated.

15. The system of claim 11, wherein the capture unit is further configured to:
fit to the product; and
ascertain an identification of the product and an identification of the capture unit.
